(19) United States
(12) Patent Application Publication
(10) Pub. No.: US 2002/0119036 A1
(43) Pub. Date: Aug. 29, 2002

(54) Installation for fabricating semiconductor products

(76) Inventors: Ronald Huber, Pough Keepsie, NY (US); Rolf-Arno Klabsch, Lostau (DE)

Correspondence Address: LERNER AND GREENBERG, P.A., PATENT ATTORNEYS AND ATTORNEYS AT LAW, Post Office Box 2480, Hollywood, FL, 33020-2480, US

(21) Appl. No.: 10/014,246

(22) Filed: Nov. 7, 2001

Related U.S. Application Data
(63) Continuation of application No. PCT/DE00/01453, filed on May 5, 2000.

(30) Foreign Application Priority Data
May 7, 1999 (DE) 199 21 246.5

(51) Int. Cl. B65G 49/07

(52) U.S. Cl. 414/626; 414/940

(57) ABSTRACT

An installation for fabricating semiconductor products includes a transport system for supplying the semiconductor products to fabrication units in a clean room. A portal crane installation includes at least one transport container which is guided above the fabrication units and which can be lowered to the fabrication units.

### CROSS-REFERENCE TO RELATED APPLICATION

This application is a continuation of copending International Application No. PCT/DE00/01453, filed May 5, 2000, which designated the United States.

### BACKGROUND OF THE INVENTION

1. Field of the Invention

The invention relates to an installation for fabricating semiconductor products.

Installations of this type can be configured as wafer processing plants as described in Published, Non-Prosecuted German Patent Application No. DE 37 35 449 A1, U.S. Pat. No. 5,803,932 or U.S. Pat. No. 5,443,346. Such installations contain a number of fabrication units, with which various fabrication processes are carried out. These processes include etching processes, wet chemical processes, diffusion processes, and various cleaning techniques such as CMP (Chemical Mechanical Polishing). One or more fabrication units are provided for each of these processes.

The overall fabrication process is subject to stringent requirements regarding cleanliness, for which reason the fabrication units are disposed in a clean room or system of clean rooms. The wafers are supplied to the individual fabrication units in cassettes in predetermined batch sizes by way of a transport system. The cassettes are also transported away with the transport system after the wafers are processed.

The transport system typically includes a conveyor system, which is constructed in the form of roll conveyors, for instance. The cassettes with the wafers are transported lying on the roll conveyors.

These types of conveyor systems run in lines through the clean room. In order to guarantee the supply of cassettes with wafers to the fabrication units, the conveyor systems branch in a suitable fashion. This way, a more or less closed network of roll conveyors is achieved within the clean room. To load and unload the fabrication units, additional handling systems can be provided, which remove the cassettes from the roll conveyors or place the cassettes on them subsequent to processing.

The disadvantage of these types of transport systems is that a rather large installation expenditure is required in order to achieve a supply of cassettes that substantially covers the entire clean room. To accomplish this, the network of roll conveyors must include a number of branchings. This does not merely mean substantial material costs because the roll conveyors in the entire clean room have a large overall length. Rather, the control expenditure for the network of the roll conveyors is also substantial.

Even when the network of roll conveyors is constructed finely branched, it is still not possible to achieve a surface-wide cassette supply in the clean room.

In order to counteract this disadvantage, the fabrication units are typically positioned according to the positions of the roll conveyors. As a result, individual fabrication units may not be properly disposed relative to one another for proper functioning. Another disadvantage of these configurations is that modifications and expansions can only be implemented at great expense.

### SUMMARY OF THE INVENTION

It is accordingly an object of the invention to provide an installation for fabricating semiconductor products which overcomes the above-mentioned disadvantages of the heretofore-known installations of this general type and which guarantees an optimal supply of semiconductor products to the fabrication units, such that the supply covers substantially the entire area of at least one clean room.

With the foregoing and other objects in view there is provided, in accordance with the invention, an installation for fabricating semiconductor products, including:

fabrication units configured to operate in a clean room;

a transport system including a portal crane installation for supplying the semiconductor products to the fabrication units, the portal crane installation including two parallel crane tracks and a carrier, the two parallel crane tracks extending above the fabrication units, the carrier extending transverse to the two parallel crane tracks, and the carrier having longitudinal ends movably mounted in the two parallel crane tracks; and

a transport container movably mounted to the carrier such that the transport container is guidable over the fabrication units and is lowerable to the fabrication units.

The transport system for supplying the semiconductor products to the fabrication units is, in accordance with the invention, constructed as a portal crane system, which includes at least one transport container that is guided over the fabrication units and can be lowered to the fabrication units.

The portal crane installation or the configuration of portal crane installations is laid out such that the transport container(s) can be moved across the entire clean room above the fabrication units. As soon as a transport container is positioned above a fabrication unit which must be supplied with semiconductor products, the transport container is lowered to a precise position in front of the fabrication unit, so that the semiconductor products can be withdrawn from the transport container and fed directly to the fabrication unit.

The essential advantage of the transport system according to the invention is its ability to move the transport container above the fabrication units without restricted guidance and to lower it to arbitrary positions in the clean room in order to unload or load the semiconductor products.

The installation expenditure for this type of transport system is very small, and therefore the operating costs of the system are lower. Another advantage is that the transport containers are positionable behind one another at arbitrary locations in the clean room. The transport times are thus very small due to the direct guiding of the transport container above the fabrication units.

Finally, it is advantageous that the fabrication units can be provided in the clean room according to their functionalities, without regard to the transport system.

Likewise, it is also possible to vary the configuration of the fabrication units in the clean room independent of the transport system.

According to another feature of the invention, the carrier includes bogies respectively disposed at the longitudinal ends of the carrier.

According to yet another feature of the invention, each of the two parallel crane tracks includes a rail guide for a respective one of the bogies.

According to another feature of the invention, the two parallel crane tracks are supported on the support pillars.

According to a further feature of the invention, the transport container is movable along the carrier.

According to another feature of the invention, the carrier includes a rail guide, and the portal crane installation includes a bogie guided in the rail guide and holding the transport container.

According to a further feature of the invention, the portal crane installation includes a holding device extendible in a vertical direction; and the transport container is fixed to the bogie via the holding device.

According to another feature of the invention, the portal crane installation includes a swivel mechanism disposed between the holding device and the transport container, the swivel mechanism moves the transport container horizontally relative to the holding device for fine positioning the transport container.

According to a further feature of the invention, a numerical control system controls a travel path of the transport container along the carrier.

According to yet a further feature of the invention, the portal crane installation includes drives with respective encapsulations.

According to another feature of the invention, the encapsulations are explosion-proof encapsulations.

According to yet another feature of the invention, the bogies have respective encapsulations.

According to a further feature of the invention, the two parallel crane tracks have contact surfaces in contact with the bogies, the contact surfaces and the bogies are formed of a wear-proof, non-outgassing material.

According to another feature of the invention, the rail guide of the carrier has a contact surface in contact with the bogie, the contact surface and the bogie are formed of a wear-proof, non-outgassing material.

According to another feature of the invention, a central control system controls the portal crane installation.

According to a further feature of the invention, the portal crane installation is configured to extend across the entire clean room.

According to a further feature of the invention, the portal crane installation and a further portal crane installation are configured to be disposed next to one another or one behind the other in the clean room.

According to another feature of the invention, the portal crane installation includes a further carrier and a further transport container movably mounted to the further carrier, the further carrier moves on the two parallel crane tracks of the portal crane installation.

According to a further feature of the invention, the carrier and the further carrier are individually movable in the portal crane installation.

According to yet a further feature of the invention, the portal crane installation includes a further transport container, the transport container and the further transport container are movably mounted one behind another to the carrier.

According to another feature of the invention, the transport container and the further transport container are individually movable.

According to yet another feature of the invention, the fabrication units and the transport system are configured to process semiconductor wafers.

With the objects of the invention in view there is also provided, a plant for fabricating semiconductor products, including:

a clean room;

fabrication units disposed in the clean room;

a transport system including a portal crane installation for supplying the semiconductor products to the fabrication units, the portal crane installation including two parallel crane tracks and a carrier, the two parallel crane tracks extending above the fabrication units, the carrier extending transverse to the two parallel crane tracks, and the carrier having longitudinal ends movably mounted in the two parallel crane tracks; and

a transport container movably mounted to the carrier such that the transport container is guidable over the fabrication units and is lowerable to the fabrication units.

Other features which are considered as characteristic for the invention are set forth in the appended claims.

Although the invention is illustrated and described herein as embodied in an installation for fabricating semiconductor products, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic plan view of an installation according to the invention for processing wafers; and

FIG. 2 is a schematic, longitudinal sectional view of the installation shown in FIG. 1.

### DESCRIPTION OF THE PREFERRED EMBODIMENTS

Referring now to the figures of the drawings in detail there is shown a schematic representation of an installation for fabricating semiconductor products, the present exemplifying embodiment being an installation for processing wafers. In order to carry out the fabrication processes which are required for processing the wafer, a number of fabrication units 2 are disposed in a clean room 1. For the sake of providing a better overview, only eight such fabrication units 2 are represented. Alternatively, the fabrication units 2 can also be distributed in several clean rooms 1.

The fabrication processes specifically include etching processes, wet chemistry techniques, diffusion processes, and cleaning methods. One or more fabrication units 2 are provided for all the fabrication processes.

The fabrication units 2 are installed at predetermined positions on the floor 3 of the clean room 1. The fabrication units 2 are operated by operating personnel via basic operator stations, which are not represented. Each of the fabrication units 2 additionally includes a respective loading and unloading station 4, via which the wafers which are being processed are inserted into the fabrication unit 2 and removed from this again following the processing.

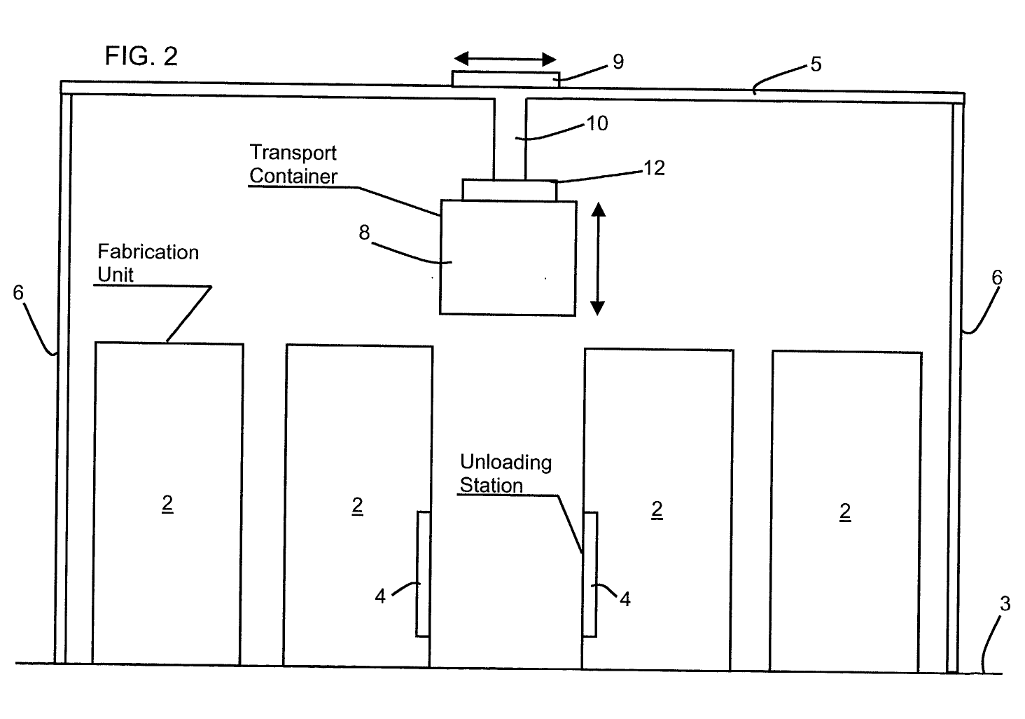

The wafers are fed to the fabrication units 2 in cassettes via a transport system. The transport system represented in the drawings is formed of a portal crane installation. The portal crane installation includes two crane tracks 5, which run above the fabrication units 2. The crane tracks 5 are respectively borne on support pillars 6, which are anchored in the floor 3 of the clean room 1. FIG. 2 represents two support pillars 6, which bear a crane track 5. It is also possible to provide several support pillars 6, depending on the length of the crane track 5. Alternatively, the crane tracks 5 can also be fixed to the ceiling of the clean room 1 in a suspended construction.

The crane tracks 5 run parallel to one another a defined distance apart and are of equal length. The crane tracks 5 are disposed in an opposing fashion at a small distance from the longitudinal interior walls of the substantially rectangular clean room 1, extending substantially across the entire length of the clean room 1.

A carrier 7 that runs transverse to the crane tracks 5 is mounted such that the ends of its longitudinal sides can be moved in the crane tracks 5. A transport container 8 for accepting cassettes with wafers is fixed to the carrier 7, whereby the transport container 8 is provided such that it can be moved in the longitudinal direction of the carrier 7.

In order to guide the carrier 7 in the crane tracks 5, respective bogie assemblies 9 are provided at the longitudinal ends of the carrier 7. Expediently, each bogie assembly 9 includes a fixed number of wheels or rollers, which are not represented. These rolls or wheels are guided in rail guides in the crane tracks 5.

The transport container 8 is fastened to a bogie 11, which is movably borne on the carrier 7, through the use of a holding device 10 which can be extended vertically in a telescoping fashion. The holding device 10 can specifically include an extendable bar or the like. The bogie 11 at the carrier 7 also expediently includes a prescribed number of rolls or wheels, which are not represented but which are movable in the carrier 7 in a rail guide. The transport container 8 can be moved along the carrier 7 through the use of the bogie 11, and in the vertical direction through the use of the holding device 10.

Lastly, a swivel mechanism 12 is provided between the holding device 10 and the transport container 8, with the aid of which the transport container 8 can be moved horizontally with respect to the holding device for purposes of fine positioning.

The travel path of the transport container 8 at the carrier 7 and the travel paths of the holding device 10 and the swivel device 12 are controlled via one or more NC (numerical control) controls. The NC controls are connected to a central control, which takes over the overall controlling of the portal crane installation. Alternatively or in addition, individual functions of the control can be manually actuated as needed.

With the portal crane installation according to the invention, arbitrarily disposed fabrication units 2 in the clean room 1 can be rapidly and easily supplied with wafers. To accomplish this, the transport container 8 is filled with cassettes with wafers in them from a store, a conveyor belt, or the like. Next, the carrier 7 at the crane tracks 5 is moved until it is located at the same height as the fabrication unit 2 which must be supplied. Specifically, the transport container 8 is moved above the fabrication units 2. This way, the transport of the wafers is not obstructed by the configuration of the fabrication units 2.

Next, the transport container 8 is moved along the carrier 7 until the transport container 8 is located above the fabrication unit 2 being supplied. Alternatively, the carrier 7 and the transport container 8 can be moved at the same time. Once the transport container 8 is positioned over the fabrication unit 2 being supplied, the transport container 8 is lowered by telescopically extending the holding device 10 until the transport container 8 is located directly in front of the loading and unloading station 4 of the fabrication unit 2. In this process of lowering the transport container 8, a simultaneous fine positioning can be accomplished by automatically or manually activating the swivel mechanism 12. The wafers are then removed, accordingly.

Since the portal crane installation extends across the entire clean room 1, the apparatus can be supplied with wafers surface-wide, i.e. in the entire clean room, wherein the movement of the transport container 8 to the respective fabrication unit 2 runs above all fabrication units 2, so that there is no restricted guidance within the travel path of the transport container 8.

To satisfy the purity and safety requirements in the clean room 1, all drives of the portal crane include an encapsulation, preferably an explosion-proof encapsulation. Expediently, the bogies 9, 11 also include an encapsulation.

Lastly, non-out gassing and highly abrasion-resistant materials are utilized for the moving parts of the bogies 9, 11, particularly for the rolls or wheels, and for the contact surfaces on the crane tracks 5 and the carrier 7 on which the bogies 9, 11 are guided. In particular, highly resistant plastics may be used.

By these measures, it is guaranteed that the moving parts of the portal crane installation will shed few particles, if any, which could pollute the atmosphere of the clean room.

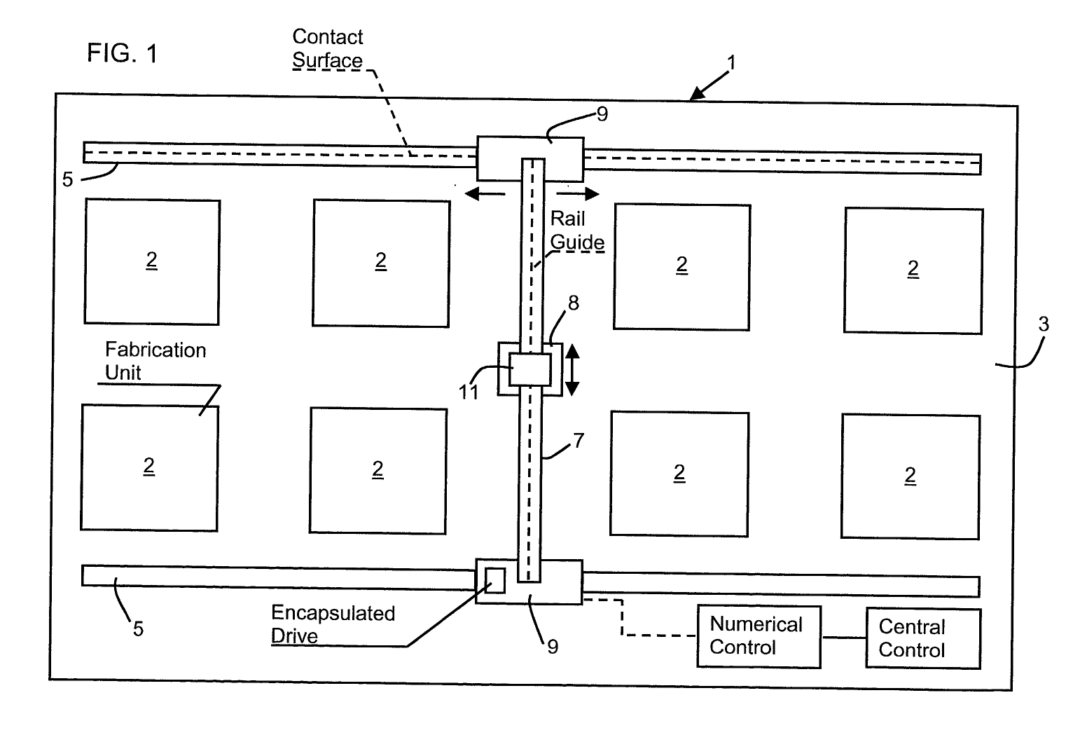

In the exemplifying embodiment represented in FIGS. 1 and 2, the wafer is transported with the aid of a portal crane installation which extends across the entire clean room 1.

In particularly large clean rooms 1, this type of portal crane installation must have a substantial span, which can lead to static or structural problems when installing the portal crane installation. In addition, unlike the exemplifying embodiment according to FIG. 1, the outline of a clean room 1 can be not only rectangular but also angled.

In such cases, it is expedient to provide a multiple configuration of portal crane installations provided next to or behind one another, in order to guarantee a surface-wide supply of wafers.

In such configurations, it is expedient to provide one or more storage systems for wafers, for instance stockers, at the boundary lines between two portal crane installations. These stores then form links between the individual portal crane installations, since the transport containers 8 can be positioned at them for loading and unloading wafers.

In an advantageous embodiment, the portal crane installation can be expanded to the effect that several carriers 7 with a transport container 8 are movably provided on the crane tracks 5 of a portal crane installation.

The carriers 7 are expediently provided at the portal crane installation in such a way that each can be moved separately, whereby the coordination of the travel paths is taken over by the central control.

In a separate advantageous embodiment, the portal crane installation can be expanded to the effect that several consecutively provided transport containers 8 are movably provided at one carrier 7.

The transport containers 8 can then be individually positioned at different fabrication units 2 or storage systems for loading and unloading. The travel paths of the transport containers 8 at a carrier 7 are coordinated by the central control.

We claim:

1. An installation for fabricating semiconductor products, comprising:
fabrication units configured to operate in a clean room;
a transport system including a portal crane installation for supplying the semiconductor products to said fabrication units, said portal crane installation including two parallel crane tracks and a carrier, said two parallel crane tracks extending above said fabrication units, said carrier extending transverse to said two parallel crane tracks, and said carrier having longitudinal ends movably mounted in said two parallel crane tracks; and
a transport container movably mounted to said carrier such that said transport container is guidable over said fabrication units and is lowerable to said fabrication units.

2. The installation according to claim 1, wherein said carrier includes bogies respectively disposed at said longitudinal ends of said carrier.

3. The installation according to claim 2, wherein each of said two parallel crane tracks includes a rail guide for a respective one of said bogies.

4. The installation according to claim 1, including support pillars, said two parallel crane tracks being supported on said support pillars.

5. The installation according to claim 1, wherein said transport container is movable along said carrier.

6. The installation according to claim 5, wherein:
said carrier includes a rail guide; and
said portal crane installation includes a bogie guided in said rail guide and holding said transport container.

7. The installation according to claim 6, wherein:
said portal crane installation includes a holding device extendible in a vertical direction; and
said transport container is fixed to said bogie via said holding device.

8. The installation according to claim 7, wherein said portal crane installation includes a swivel mechanism disposed between said holding device and said transport container, said swivel mechanism moves said transport container horizontally relative to said holding device for fine positioning said transport container.

9. The installation according to claim 1, including a numerical control system controlling a travel path of said transport container along said carrier.

10. The installation according to claim 1, wherein said portal crane installation includes drives with respective encapsulations.

11. The installation according to claim 10, wherein said encapsulations are explosion-proof encapsulations.

12. The installation according to claim 2, wherein said bogies have respective encapsulations.

13. The installation according to claim 6, wherein said bogie has an encapsulation.

14. The installation according to claim 2, wherein said two parallel crane tracks have contact surfaces in contact with said bogies, said contact surfaces and said bogies are formed of a wear-proof, non-outgassing material.

15. The installation according to claim 6, wherein said rail guide of said carrier has a contact surface in contact with said bogie, said contact surface and said bogie are formed of a wear-proof, non-outgassing material.

16. The installation according to claim 1, including a central control system controlling said portal crane installation.

17. The installation according to claim 1, wherein said portal crane installation is configured to extend across the entire clean room.

18. The installation according to claim 1, including a further portal crane installation, said portal crane installation and said further portal crane installation being configured to be disposed next to one another in the clean room.

19. The installation according to claim 1, including a further portal crane installation, said portal crane installation and said further portal crane installation being configured to be disposed one behind another in the clean room.

20. The installation according to claim 1, wherein said portal crane installation includes a further carrier and a further transport container movably mounted to said further carrier, said further carrier moves on said two parallel crane tracks of said portal crane installation.

21. The installation according to claim 20, wherein said carrier and said further carrier are individually movable in said portal crane installation.

22. The installation according to claim 1, wherein said portal crane installation includes a further transport container, said transport container and said further transport container are movably mounted one behind another to said carrier.

23. The installation according to claim 22, wherein said transport container and said further transport container are individually movable.

24. The installation according to claim 1, wherein said fabrication units and said transport system are configured to process semiconductor wafers.

25. A plant for fabricating semiconductor products, comprising:
a clean room;
fabrication units disposed in said clean room;
a transport system including a portal crane installation for supplying the semiconductor products to said fabrication units, said portal crane installation including two parallel crane tracks and a carrier, said two parallel crane tracks extending above said fabrication units, said carrier extending transverse to said two parallel crane tracks, and said carrier having longitudinal ends movably mounted in said two parallel crane tracks; and
a transport container movably mounted to said carrier such that said transport container is guidable over said fabrication units and is lowerable to said fabrication units.
